(19) United States
(12) Patent Application Publication
(10) Pub. No.: US 2020/0071972 A1
(43) Pub. Date: Mar. 5, 2020

(54) AMORPHOUS METAL APPARATUS

(71) Applicant: FORD MOTOR COMPANY, Dearborn, MI (US)

(72) Inventors: Stuart C. Salter, White Lake, MI (US); Paul Kenneth Dellock, Northville, MI (US); Jim J. Surman, Clinton Township, MI (US); David Brian Glickman, Southfield, MI (US)

(21) Appl. No.: 16/117,193

(22) Filed: Aug. 30, 2018

(51) Int. Cl. E05B 85/10; B32B 1/00; B32B 15/08; E05B 85/12; B60Q 1/26; F21S 41/141; F21S 45/47

(52) U.S. Cl. CPC E05B 85/10; B32B 1/00; B32B 15/08; E05B 85/12; B60Q 1/2669; F21Y 2115/10; F21S 45/47; B32B 2307/302; B32B 2605/08; B32B 2307/702; F21S 41/141

(57) ABSTRACT

A method of forming and an apparatus that may include an amorphous metal shell having a visible surface and an opposed back surface, and a thermally conductive plastic member secured to the back surface. The apparatus may be a door handle for a vehicle. The apparatus may be formed by molding an amorphous metal shell having a visible surface and an opposed back surface, and molding a thermally conductive plastic member to the back surface.

### BACKGROUND OF THE INVENTION

The present invention relates to an apparatus, and in particular to an apparatus having an amorphous metal surface.

Amorphous metals have been employed as thin surfaces overmolded over other materials in order to provide a desired surface finish, and in particular a surface finish that creates the appearance of an all metal apparatus. However, when one touches the amorphous metal surface, it may become apparent to the user that the apparatus has a feeling of a thin plastic painted or plated part. This may create an appearance to the user of an inexpensive plastic apparatus, rather than having a more luxurious feel (to go along with the luxurious look) for the apparatus.

### SUMMARY OF THE INVENTION

An embodiment contemplates an apparatus that includes an amorphous metal shell having a visible surface and an opposed back surface; and a thermally conductive plastic member secured to the back surface. The apparatus may be a door handle for a vehicle.

An embodiment contemplates a method for forming an apparatus that may include molding an amorphous metal shell having a visible surface and an opposed back surface, and molding a thermally conductive plastic member to the back surface.

An advantage of an embodiment is that an apparatus may be formed mostly from a cheaper material, such as plastic, yet have the look and feel of a solid metal apparatus, thus creating an image of a luxury apparatus. This amorphous metal apparatus may have the appearance and feel of a solid metal apparatus, but be less expensive and weight less than an all metal version of the apparatus. In addition, the amorphous metal on the surface of the apparatus is corrosion, dent, wear and scratch resistant. The amorphous metal may be formed dimensionally precise, while also being formed with a desirable surface look/texture (shiny, glossy, matt, satin, etc.).

### BRIEF DESCRIPTION OF THE DRAWINGS

FIG. 1 is a schematic, perspective view of a portion of a vehicle structure, including a door handle assembly.

FIG. 2 is a cross section through a portion of a door handle.

FIG. 3 is a cross section through a portion of a door handle, according to another embodiment.

FIG. 4 of a perspective view of an apparatus in a vehicle interior.

### DETAILED DESCRIPTION

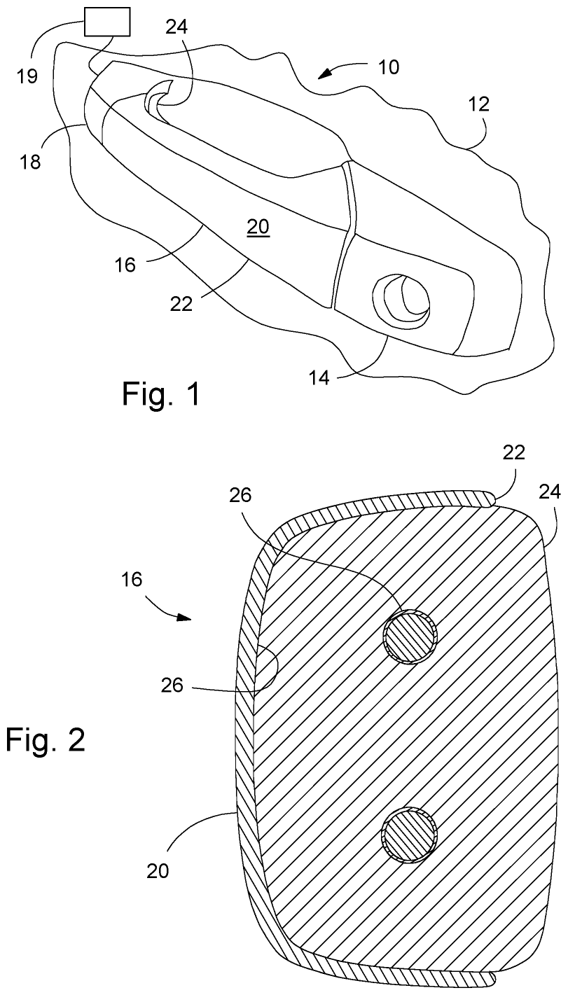

FIG. 1 illustrates an apparatus, which may be, for example, a door handle assembly 10 mounted to structure 12, such as the structure of a vehicle. The door handle 10 may have a key portion 14 fixed to the structure 12 and a pivotable handle 16, that pivots relative to a base 18 fixed to the structure. The handle 16 may be shaped to receive the fingers of a user for gripping and pulling on the handle 16 to unlatch a door, and the structure may be shaped to provide easy access to fingers for gripping the handle 16. Access to a selectively activatable source of electricity 19 (shown schematically) may also be supplied to the door handle assembly 10.

An outer (visible) surface 20 of the assembly 10 may be formed by an amorphous metal shell 22, thus giving the appearance of a metal element and also providing for corrosion, scratch and dent resistance. Amorphous metal may also be referred to as bulk metal glass. Inner portions (generally not visible) 24 may be generally made of thermally conductive plastic, with possible inserts (discussed below).The inner portions 24 may provide support for the shell 22 (increasing strength of the part), as well as providing the shape needed for desired functioning of the assembly 10, while minimizing overall weight of the assembly 10.

FIG. 2, discussed with reference to FIG. 1, shows a possible cross section of the handle 16. The shell 22 defines the visible surface 20 and may be molded to the desired shape using the amorphous metal materials—for example, injection molding of the amorphous metal may be employed to form the shell 22. This process generally allows for the visible surface to appear as desired right out of the mold with little or no further finishing to the visible surface 20. The shell 22 thickness may be about 1 to 1.5 millimeters, although other thicknesses may be used if so desired. The amorphous metal may be made, for example, from a material such as a zirconium based alloy or a nickel chromium alloy.

The thermally conductive plastic inner portions 24 may be molded to a back (inner) surface 26 (opposite the visible surface). The shell 22 may be molded first, with thermally conductive plastic 24 second shot/overmolded to the shell 22. In order to promote adhesion of the thermally conductive plastic inner portions 24 to the amorphous metal shell 22, the back surface 2 of the shell 22 may be molded with a rough grain. The thermally conductive plastic may employ, for example, boron nitride.

The thermally conductive plastics are plastics with thermal conductivity similar to some commonly used metals. For example, typical conventional thermoplastics may have a thermal conductivity around 0.2 Watts/meter-Kelvin (W/mK), whereas thermally conductive plastics may have about 10-50 times higher thermal conductivity (e.g., 1-10 W/mK), and even as high as 100-500 times (e.g., 10-100 W/mK). This compares to conventional die case metal alloys of magnesium or aluminum in the 50-100 W/mK range or conventional extruded aluminum alloys that may be about 150 W/mK. Consequently, as used herein, the term thermally conductive plastic includes plastics having a thermal conductivity of at least one W/mK, and preferably higher thermal conductivity in the range of 10-100 W/mK.

As part of the molding of the plastic 24, heating elements 26 may be molded into the plastic portions 24. The heating elements 26 may be connected to the source of electricity 19. Thus when the source 19 is activated, the heat radiates from the elements 26 into the surrounding thermally conductive plastic 24. The heating elements 26 may be employed, for example, when a user is detected approaching the vehicle, or when the vehicle is remote started, and the ambient temperature is detected as below a given temperature. This may help to melt snow/ice from the handle and warm the handle prior to contact with the user's fingers.

The thermally conductive plastic 24 molded to the amorphous metal shell 22 produces, when a user's fingers grip the handle 16, the feeling of a higher thermal conductivity that is present in apparatuses that are all metal, as opposed to conventional plastic parts that have low thermal conductivity. Thus, this high thermal conductivity produces a feeling of luxury from what feels like an all metal apparatus, rather than providing the person with a cheap plastic feeling of the apparatus when touched.

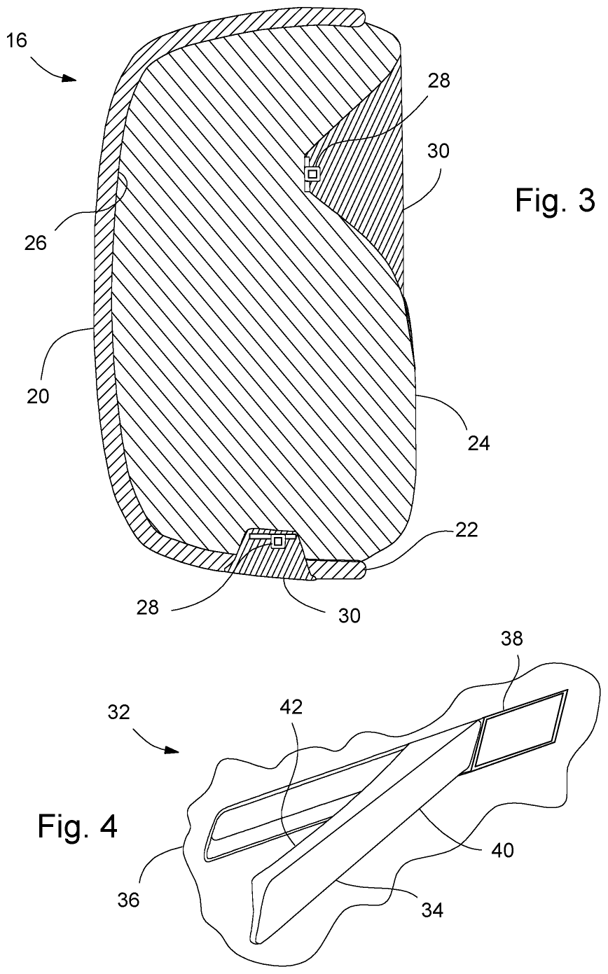

FIG. 3, discussed with reference to FIG. 1, shows a possible cross section of the handle 16. The shell 22 defines the visible surface 20 and is formed from amorphous metal, similar to the embodiment of FIG. 2. The thermally conductive plastic inner portions 24 again may be molded to a back surface 26, similar to the embodiment of FIG. 2.

In this embodiment, as part of the molding of the plastic 24, light emitting diodes (LEDs) 28 may be insert molded into the thermally conductive plastic 24, with optics 30 overmolded over the LEDs 28. The LEDs may be connected to the source of electricity 19, thus allowing the LEDs to be activated to produce light when desired. Additionally, with this configuration, the thermally conductive plastic 24 may act as a heat sink to absorb the heat produced by the LEDs, thus allowing for higher electrical power LEDs to be used. For example, one of the LEDs may act at a puddle lamp, while the other adds accent lighting to the rear of the handle 16 for ease in seeing the handle for gripping or unlocking the door handle. If a thermally conductive plastic using boron nitride is employed, then the plastic is generally white, which makes a good reflector for the light from the LEDs.

FIG. 4 illustrates a apparatus 32 similar to the apparatus of FIG. 1, but such apparatus 32 may be, for example, a door handle or switch 34 in a vehicle interior 36, and may also include elements 38 such as emblems, lighting bezels, key holes, molding, interior trim, and other types of apparatuses. The amorphous metal shell(s) 40, with thermally conductive plastic inner portions 42, may be provided with the luxury look and feel, while providing the desired durability of the surface finish, as well as low cost and weight, as discussed relative to the door handle of FIG. 1.

While certain embodiments of the present invention have been described in detail, those familiar with the art to which this invention relates will recognize various alternative designs and embodiments for practicing the invention as defined by the following claims.

1. An apparatus comprising:
an amorphous metal shell having a visible surface and an opposed back surface; and
a thermally conductive plastic member secured to the back surface.

2. The apparatus of claim 1 further including a heating element, connectable to an electric source, extending through the plastic member.

3. The apparatus of claim 2 wherein the amorphous metal shell and the plastic member form a pivotable door handle.

4. The apparatus of claim 1 further including a light emitting diode secured within the plastic member.

5. The apparatus of claim 4 further including a light optic mounted adjacent to the light emitting diode and configured to direct light emanating from the plastic member.

6. The apparatus of claim 4 wherein the amorphous metal shell and the plastic member form a pivotable door handle.

7. The apparatus of claim 6 further including a second light emitting diode secured within the plastic member, spaced from the light emitting diode, and oriented to project light in a different direction from the light emitting diode.

8. The apparatus of claim 6 wherein the pivotable door handle is part of an exterior door handle assembly on a vehicle.

9. The apparatus of claim 6 wherein the pivotable door handle is mounted to structure in a vehicle interior.

10. A method for forming an apparatus comprising:
molding an amorphous metal shell having a visible surface and an opposed back surface; and
molding a thermally conductive plastic member to the back surface.

11. The method of claim 10 wherein the plastic member is second shot molded to the amorphous metal shell.

12. The method of claim 10 wherein the back surface is molded with a rough grain.

13. The method of claim 10 further comprising, molding the plastic member around a heating element.

14. The method of claim 10 further comprising, insert molding a light emitting diode into the plastic member.

15. The method of claim 14 further comprising, molding optics to the plastic member over the light emitting diode.
